(19) United States
(12) Patent Application Publication
(10) Pub. No.: US 2024/0373838 A1
(43) Pub. Date: Nov. 14, 2024

(54) Tree Stand

(71) Applicant: Benjamin Jones, Parrish, FL (US)

(72) Inventor: Benjamin Jones, Parrish, FL (US)

(21) Appl. No.: 18/601,279

(22) Filed: Mar. 11, 2024

Related U.S. Application Data
(60) Provisional application No. 63/501,470, filed on May 11, 2023.

(51) Int. Cl. A01M 31/02

(52) U.S. Cl. CPC A01M 31/02

(57) ABSTRACT

A tree stand and method of installing includes a rail system, a seat portion and a foot-rest portion. The seat portion and the rail portion are held to the rail portion by a climber mechanism that locks each to the rail upon downward pressure but allows each to be lifted to disengage with the rail for moving up/down the rail. By alternately locking/disengaging the climber mechanism with the rail, a user successively moves the foot-rest portion higher on the rail, then moves the seat portion higher on the rail until both are at a desired height.

### BACKGROUND OF THE INVENTION

Many hunters erect tree stands in which the hunter stands/sits while waiting for their prey to arrive. Tree stands are elevated platforms that are secured to trees to elevate the hunter, resulting in a better vantage point. A tree stand is an effective tool for hunting, especially when hunting deer, as by being elevated, it is more difficult for the deer to pick up the scent of the hunter.

Existing tree stands are fastened to a tree at a high altitude, either using straps or direct attachment. In order to get the tree stand to the appropriate altitude, the hunter needs to use a ladder and carry the tree stand up the tree to the altitude where it is to be attached, then attach the tree stand to the tree at the desired height. This all seems rather easy, except that hunting is typically performed in the wilderness where there are typically very few ladders, and it is very difficult to carry a ladder to the location that the hunter wishes to place the tree stand. Further, due to uneven surfaces, it is very dangerous to climb, especially because if one falls so far into the wilderness, it will be very difficult to get help. Further, once the tree stand is erected, it is difficult to relocate to a different location, again requiring a ladder be moved to the wilderness for removing, then reinstalling the tree stand.

Another problem with many existing tree stands is having multiple hunting spots. It is difficult to relocate most existing tree stands to a different tree.

Another problem with many existing tree stands occurs when the hunter wishes to hunt from different locations, moving back and forth between locations during different hours of the day. As it is difficult to relocate most existing tree stands, if the hunter wants to be able to move back and forth between different locations, the hunter will need to own and erect multiple tree stands, one for each location.

There is an existing tree stand that uses cables that travers the tree. As this prior tree stand is raised, the cables must be relocated by loosening one cable and sliding it up, tightening it, then loosening another cable and sliding that cable up, and again tightening that cable. This method and apparatus of the prior art requires that tree limbs be cut to enable the cable to be raised as the tree limbs will get in the way of raising the cables, and, therefore, would work on a telephone pole, but required damaging a tree in the habitat where it is typically used.

What is needed is a tree stand system that will easily erect without the use of a ladder and be relocatable.

### SUMMARY OF THE INVENTION

In one embodiment, a tree stand is disclosed including a rail that has a mechanism for attaching to the tree and has a plurality of holes on a face surface (the surface facing away from the tree). Rail climber mechanisms have a front, a top edge, a bottom edge, and L-shaped sides, the L-shaped sides extend from the front and engage with the rail, slideably holding each of the rail climber mechanisms to the rail. A peg is affixed or formed on an inside surface of the front between the bottom edge and a mid-point between the bottom edge and the top edge, and the L-shaped sides are wider at the bottom edge than at the top edge for enabling engagement and disengagement of the peg from the holes of the rail. A seat portion is affixed to a first rail climber mechanism of the rail climber mechanisms and a foot-rest portion is affixed to a second rail climber mechanism of the rail climber mechanisms. The peg of the first rail climber mechanism engages with a first hole of the rail until the seat portion is lifted and the peg of the second rail climber mechanism engages with a second hole of the rail until the foot-rest portion is lifted.

In another embodiment, a tree stand system is disclosed including a rail that has at least two brackets and a plurality of holes formed on a face surface of the rail. A first rail climber mechanism that has a first front, a first top edge, a first bottom edge, and two first L-shaped sides. The two first L-shaped sides extend from the first front and engage with the rail, slideably holding the first rail climber mechanism to the rail. A first peg is affixed or formed on a first inside surface of the first front between the first bottom edge and a first mid-point between the first bottom edge and the first top edge. Each of the two first L-shaped sides is wider at the first bottom edge than at the first top edge. A seat portion is affixed to the first rail climber mechanism. A second rail climber mechanism has a second front, a second top edge, a second bottom edge, and two second L-shaped sides. The two second L-shaped sides extend from the second front and engage with the rail, slideably holding the second rail climber mechanism to the rail. A second peg is affixed or formed on a second inside surface of the second front between the second bottom edge and a second mid-point between the second bottom edge and the second top edge. Each of the two second L-shaped sides are wider at the second bottom edge than at the second top edge. A foot-rest portion is affixed to the second rail climber mechanism and a top surface of the foot-rest portion has at least one foot strap. The first peg of the first rail climber mechanism engages with a first hole of the rail until the seat portion is lifted and the second peg of the second rail climber mechanism engages with a second hole of the rail until the foot-rest portion is lifted.

In another embodiment, a method of installing a tree stand to a tree is disclosed including affixing a rail to the tree. The rail has a plurality of holes. A climber mechanism of a seat portion is slideably affixed to the rail from a bottom end of the rail by sliding the climber mechanism of the seat portion up the rail to a first desired height then engaging a peg of the climber mechanism of the seat portion into a first hole of the rail. Next, a climber mechanism of a foot-rest portion is slideably affixed to the rail from the bottom end of the rail by sliding the climber mechanism of the foot-rest portion up the rail to a second desired height, the second desired height being lower than the first desired height, then engaging a peg of the climber mechanism of the foot-rest portion into a second hole of the rail. The user then climbs onto the tree stand, resting their feet on the foot-rest portion and positioning their body on the seat portion, placing at least one foot of their feet under a foot strap that is affixed to the foot-rest portion. Now, until reaching a final height, the user lifts the foot-rest portion using their legs, disengaging a peg of the climber mechanism of the foot-rest portion then further lifting the foot-rest portion, then lowering the foot-rest portion such that the peg of the climber mechanism of the foot-rest portion engages with a destination hole of the rail that is higher than the second hole then the user lifts the seat portion, disengaging the peg of the climber mechanism of the seat portion then further lifting the seat portion, then lowering the seat portion such that the peg of the climber mechanism of the seat portion engages with a second destination hole of the rail that is higher than the first hole.

### BRIEF DESCRIPTION OF DRAWINGS

The invention can be best understood by those having ordinary skill in the art by reference to the following detailed description when considered in conjunction with the accompanying drawings in which:

FIG. 1 illustrates a side elevational view of a tree stand.

FIG. 2 illustrates a front elevational view of a tree stand.

FIG. 3 illustrates a side view of mounting a rail of the tree stand to a tree.

FIG. 4 illustrates a perspective view of mounting a rail of the tree stand to a tree.

FIG. 5 illustrates a perspective view of a rail climber mechanism of the tree stand.

FIG. 6 illustrates a perspective cross-sectional view of the rail climber mechanism of the tree stand interfaced around the rail of the tree stand.

FIG. 7 illustrates a cross-sectional view of the rail climber mechanism of the tree stand.

FIG. 8 illustrates a cross-sectional view of the rail climber mechanism of the tree stand interfaced around the rail of the tree stand with a peg of the rail climber mechanism in a disengaged position.

FIG. 9 illustrates a cross-sectional view of the rail climber mechanism of the tree stand interfaced around the rail of the tree stand with a peg of the rail climber mechanism in an engaged position.

FIG. 10 illustrates a side elevational view showing two of the rails of the tree stand being connected to each other.

FIG. 11 illustrates a side elevational view the two the rails of the tree stand after being connected to each other.

FIG. 12 illustrates a side elevational view showing the seat portion of the tree stand being lifted onto the rails of the tree stand.

FIG. 13 illustrates a side elevational view showing the seat portion of the tree stand engaged with the rails of the tree stand and the foot-rest portion of the tree stand being lifted onto the rails of the tree stand.

FIG. 14 illustrates a side elevational view showing the seat portion of the tree stand and the foot-rest portion of the tree stand engaged with the rails of the tree stand.

### DETAILED DESCRIPTION OF THE INVENTION

Reference will now be made in detail to the presently preferred embodiments of the invention, examples of which are illustrated in the accompanying drawings. Throughout the following detailed description, the same reference numerals refer to the same elements in all figures.

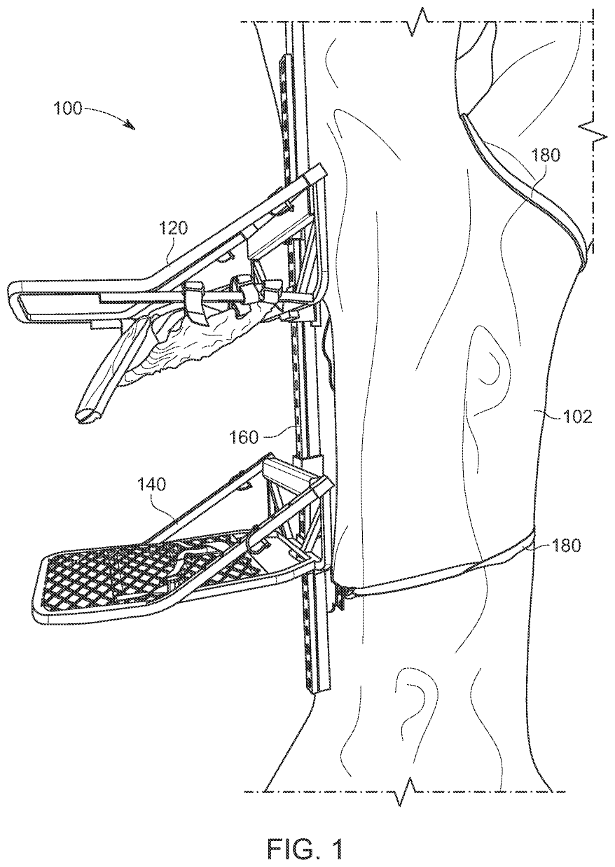

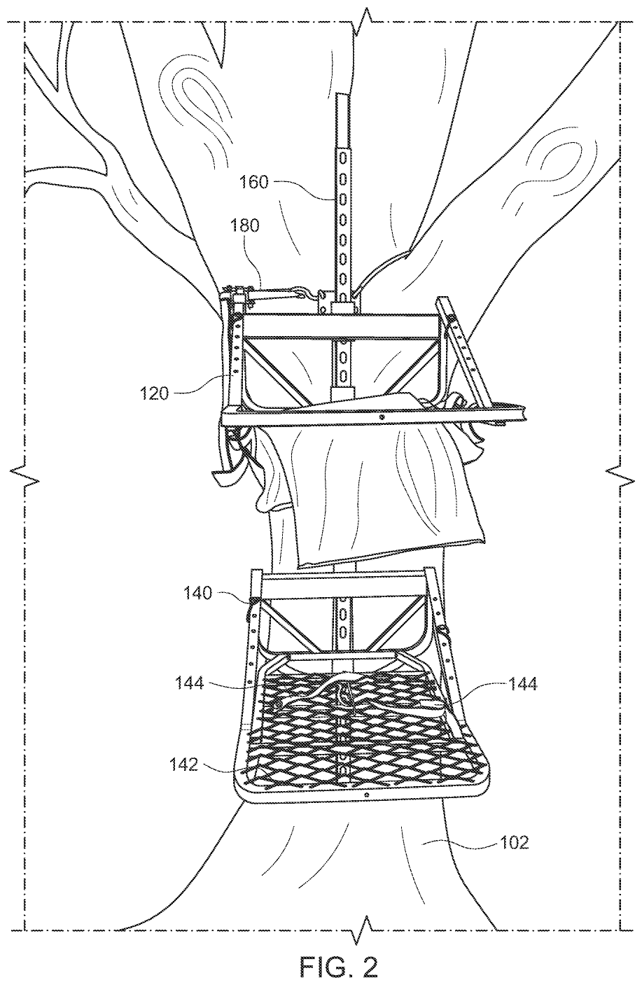

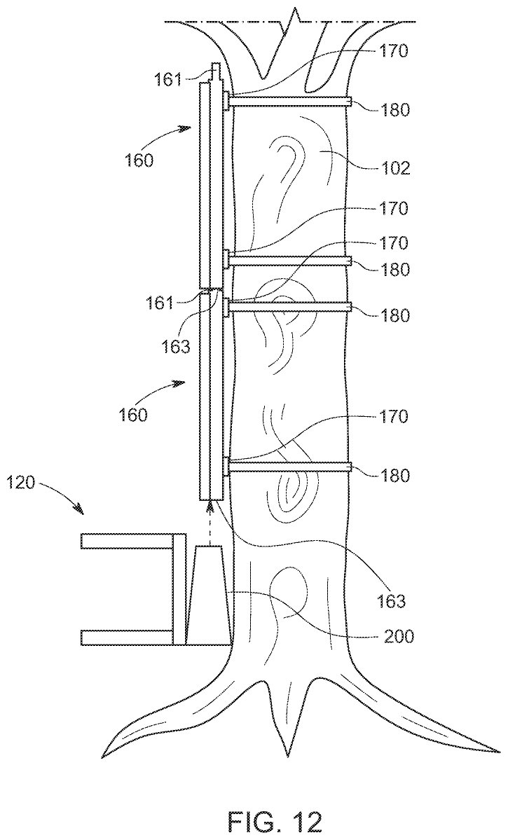

Referring to FIG. 1 and FIG. 2, a side elevational view and a perspective view of a tree stand 100 are shown. The tree stand 100 is provided in three or more components. A first component of the tree stand 100 is the seat portion 120 which is either a sitting area or a standing area as desired. Any configuration of seat portion 120 is anticipated, some having an actual seat for the user to sit upon, some having an area to hold the user from falling, etc. The second component of the tree stand 100 is a foot-rest portion 140 on which the user's feet rest. The foot-rest portion 140 has a surface 142 with foot straps 144 through which the user places their feet to be able to pull up on the foot-rest portion 140 for lowering the foot-rest portion 140, the operation of which will be shown with FIGS. 12-14. The third (and so on) component of the tree stand 100 is/are rails 160. In such, one or more rails 160 are connected in series depending upon the height desired by the hunter. A length of each rail 160 is based upon manufacturing, shipping, and deployment requirements as it is anticipated that the hunter will transport one or more of the rails 160 into the wilderness for installation on a tree 102. As the rails 160 easily connect to each other to make a longer rail, any lengthy rail is anticipated, for example, having a length between three feet long and 8 feet long, though it is desirable, but not required, that each section of rail 160 fit in a bed of a pickup truck.

The rail 160 is held against the tree 102 by straps 180, ropes, or any known or future attachment mechanism. It is also anticipated that, in some embodiments, the rails 160 be held to the tree 102 with fasteners such as screws or bolts, but this solution has the potential to harm the tree 102. Note that although the rails 160 are shown and described being affixed vertically to a tree 102, there is no limitation as to the use of the tree stand 100 and it is fully anticipated that the novel mechanisms for achieving installation heights, as will be described, be adapted to other uses having similar rails 160 that attach to whatever the user desires and having the seat portion 120 and foot-rest portion 140 to be used for any other purpose.

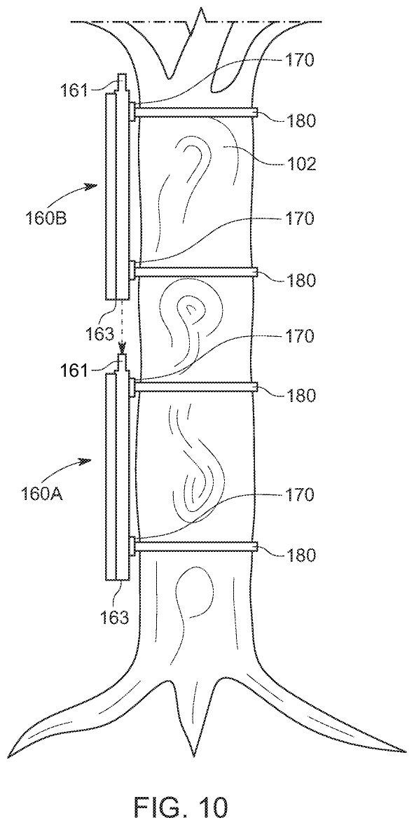

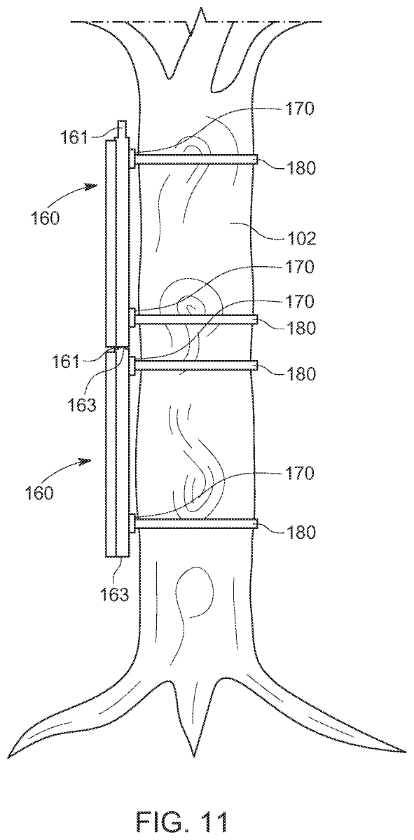

Also, in FIGS. 1 and 2, only a single section of the rail 160 is shown for brevity and clarity reason and, as per FIGS. 10 and 11, it is fully anticipated to attach multiple sections of the rails 160 together to form a longer rail.

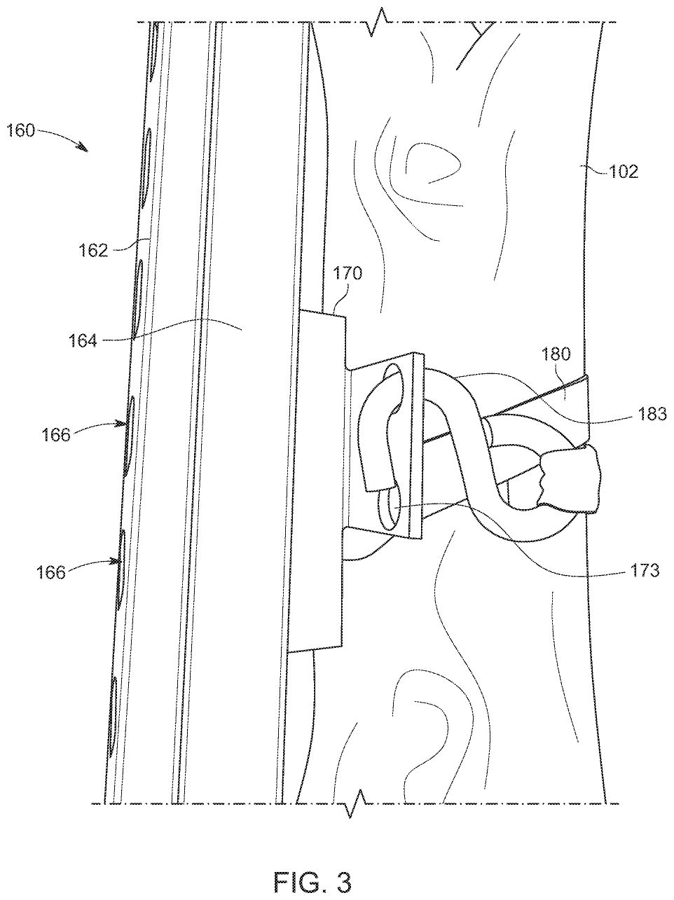

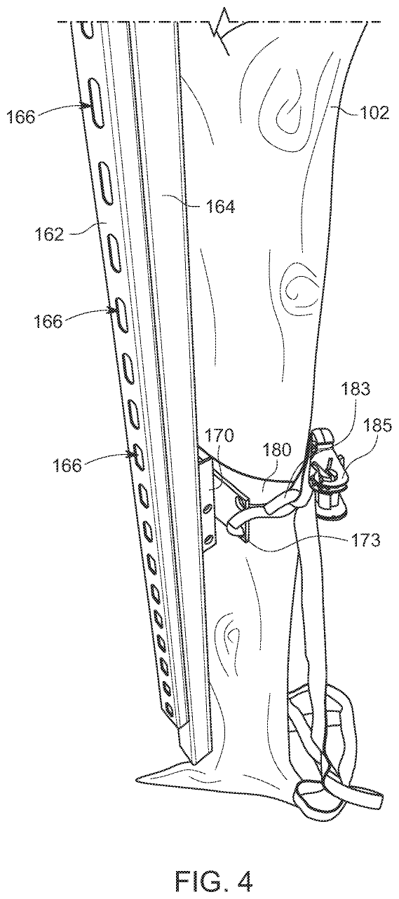

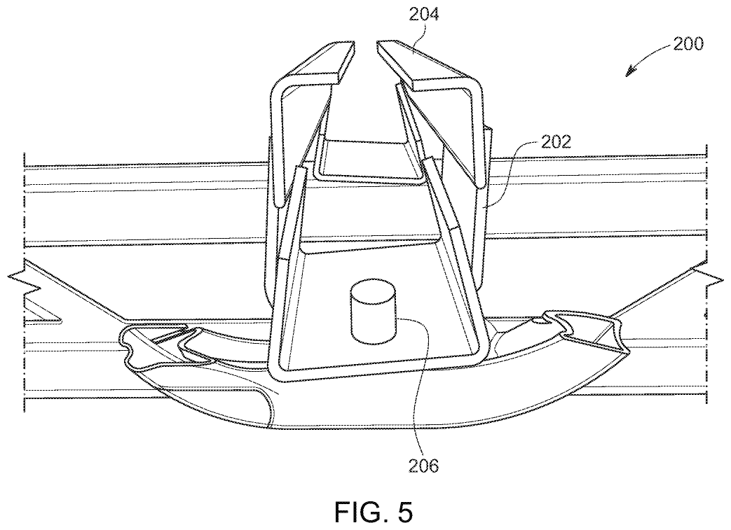

Referring to FIG. 3 and FIG. 4, views of mounting the rail 160 of the tree stand 100 strapped to a tree 102 are show. In this embodiment, the rail 160 comprises an engagement bar 162 affixed to a structural bar 164. In such embodiments, the engagement bar 162 is affixed (e.g., welded or bolted) or made as part of the structural bar 164. The engagement bar 162 has one or more engagement holes 166 that are spaced along a face of the engagement bar 162 for interfacing with a peg 206 of the rail climber mechanism 200 (see FIG. 5). Although not required, it is anticipated that there are several engagement holes 166 that are equally spaced along the engagement bar 162.

For affixing the rail 160 to a tree 102 (or other substantially vertical structure), a bracket 170 is affixed to or formed with the rail 160. The bracket 170 has holes or slots 173 for accepting connectors 183 that are affixed to the straps 180. It is anticipated that the straps 180 have a tightening mechanism such as a rachet tightening mechanism 185 to tighten the strap 180 around the tree 102 or other structure.

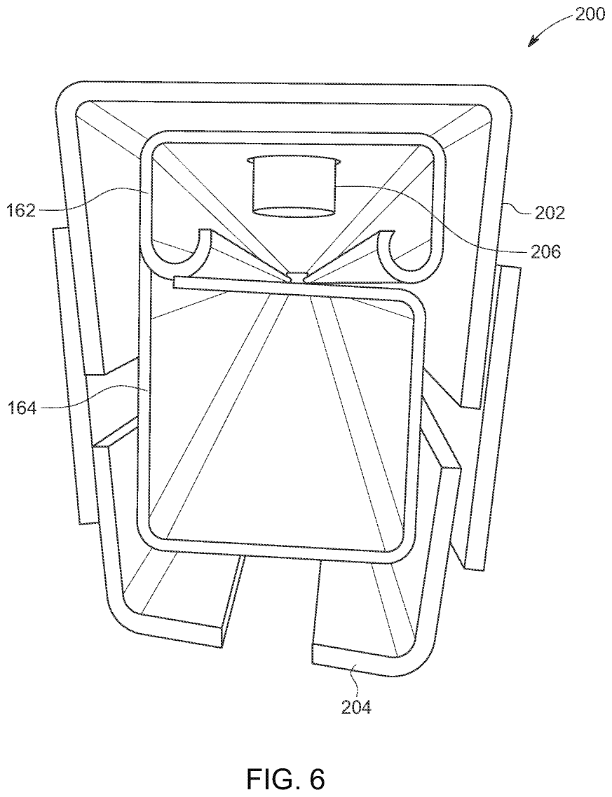

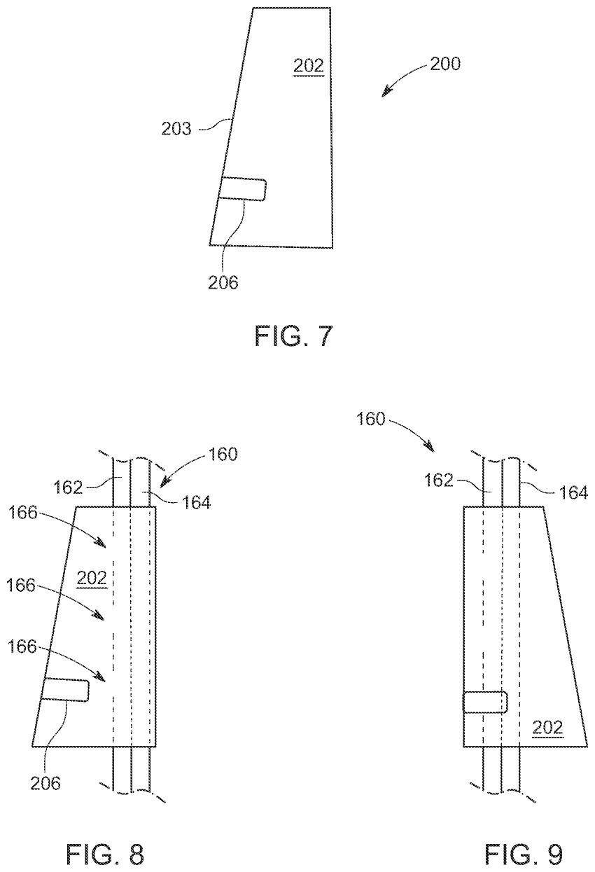

Referring to FIG. 5, FIG. 6, and FIG. 7 views view of the rail climber mechanism 200 of the tree stand 100 are shown. As will be discussed, both the seat portion 120 and the foot-rest portion 140 have a rail climber mechanism 200. The rail climber mechanism 200 provides for the ability to securely engage both of the seat portion 120 and the foot-rest portion 140 to the rail 160 by wrapping around the rail 160 as shown in FIG. 6. So that the seat portion 120 and the foot-rest portion 140 do not pull away from the rail 160 and for locking seat portion 120 and/or the foot-rest portion 140 in place at a desired height by way of the peg 206 engaging with an engagement hole 166 of the rail 160. When raising or lowering the seat portion 120 and foot-rest portion 140, the peg 206 of the rail climber mechanism 200 is disengaged from the engagement hole 166 of the rail 160 and the respective seat portion 120 or foot-rest portion 140 is lifted or lowered depending upon the desired direction that the respective seat portion 120 or foot-rest portion 140 is to be moved.

Although in some embodiments, the rail climber mechanism 200 is formed by extrusion or other manufacturing process as a single part, in the embodiment shown, the rail climber mechanism includes a pair of L-shaped sides 204 affixed (e.g., welded) to a U-shaped channel 202 and the peg 206 is affixed to the U-shaped channel 202 (e.g., welded to the U-shaped channel 202). The L-shaped sides 204 grip around back edges of the rail 160 and the space between the L-shaped sides 204 allows for the rail climber mechanism 200 to move up and down the rail 160 without getting stuck at the bracket 170. In some embodiments, the peg 206 is located between a bottom edge of the rail climber mechanism 200 and a midpoint between a top edge and bottom edge of the rail climber mechanism 200 at a location such that the peg 206 will align with the engagement holes 166 of the rail 160.

In FIG. 6, the peg 206 is engaged with one of the engagement holes 166.

Referring to FIG. 8, and FIG. 9, cross-sectional views of the rail climber mechanism 200 are shown interfaced around the rail 160 of the tree stand 100 in engagement/disengagement operation. For clarity and brevity, the seat portion 120 or foot-rest portion 140 are not shown, but it is anticipated that either the seat portion 120 or foot-rest portion 140 be affixed to a rail climber mechanism 200 (e.g., at a face of the rail climber mechanism 200 which is the side that is distal from the tree 102 or other structure). In FIG. 8, it is assumed that the attached seat portion 120 or foot-rest portion 140 are being pushed/pulled in an upward direction (e.g., upwardly with respect to the tree 102 or other structure to which the rail 160 is affixed). This upward force cantilevers the wider lower section of the rail climber mechanism 200 to disengage the peg 206 from the engagement holes 166, allowing for upward movement of the rail climber mechanism 200 and attached seat portion 120 or foot-rest portion 140. Note that the same operation is used to lower the seat portion 120 or foot-rest portion 140 by way of applying the cantilever force to the seat portion 120 or foot-rest portion 140 while allowing the seat portion 120 or foot-rest portion 140 to move downward along the rail 160.

In FIG. 9, downward force either from the weight of the seat portion 120 or foot-rest portion 140 or from the weight of a user standing/sitting on the seat portion 120 or foot-rest portion 140 forces the wider area of the rail climber mechanism 200 to tilt towards the tree 102 (or other substantially vertical support), pushing the peg 206 into one of the engagement holes 166, thereby not allowing vertical movement of the seat portion 120 or foot-rest portion 140 until such downward pressure abates as above.

Referring to FIG. 10 and FIG. 11, elevational views show two of the rails 160A/160B of the tree stand being connected to each other (FIG. 10) and connected to each other (FIG. 11). It is anticipated that the user starts by affixing a first rail section 160A to the tree 102 (or other structure) using straps 180 or any other mechanism and tightening the straps 180 or other mechanism to secure the first rail section 160A to the tree 102. To provide clearance for installing the seat portion 120 and the foot-rest portion 140 onto the rail, the first rail section 160A need be positioned above the ground and any obstacles, for example, the bottom of the first rail section 160A is positioned two feet above the ground.

Next, a second rail section 160B is strapped to the tree 102 above the first rail section 160A and the straps are not tightened until the rail connection mechanism 161/163 are engaged to hold the first rail section 160A aligned with the second rail section 160B. After the rail connection mechanism 161/163 are engaged to hold the first rail section 160A aligned with the second rail section 160B, the straps 180 of the second rail section 160B are tightened to secure the second rail section 160B to the tree 102 (or other structure).

Note that the rail connection mechanism 161/163 shown includes a narrowed section 161 of the first rail section 160A fitting snuggly within an open end 163 of the second rail section 160B but in other embodiments, any rail connection 161/163 is anticipated such as using one or more a peg and mating hole(s), etc.

The process for moving attached seat portion 120 and/or or foot-rest portion 140 up the rail 160 will now be described.

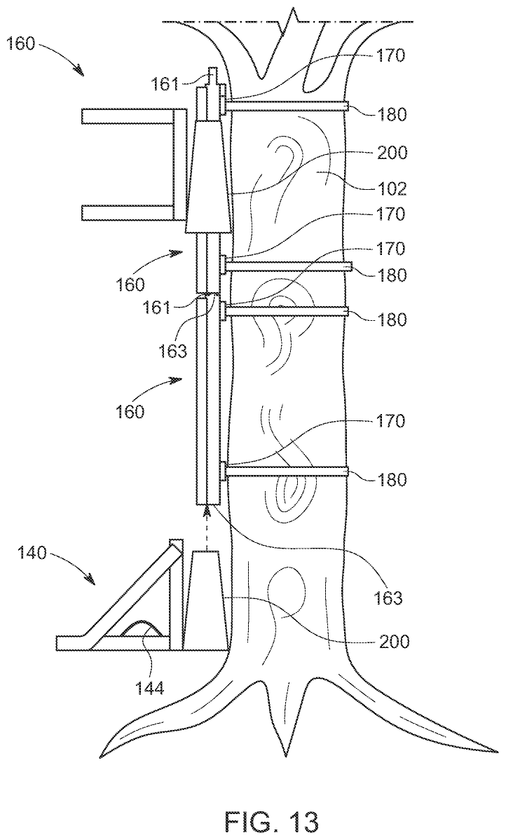

Referring to FIG. 12, a side elevational view showing the seat portion 120 of the tree stand 100 being lifted onto the rail 160 of the tree stand 100 is shown. As the seat portion 120 is lifted, the rail climber mechanism 200 will cantilever outward (away from the tree 102) and the peg 206 will remain away from the holes in the rail 160. Once the seat portion 120 is at a preferred level (see FIG. 13), the weight of the seat portion 120 will cause the rail climber mechanism 200 will cantilever inwardly and allow the peg 206 to rest in the nearest engagement hole 166.

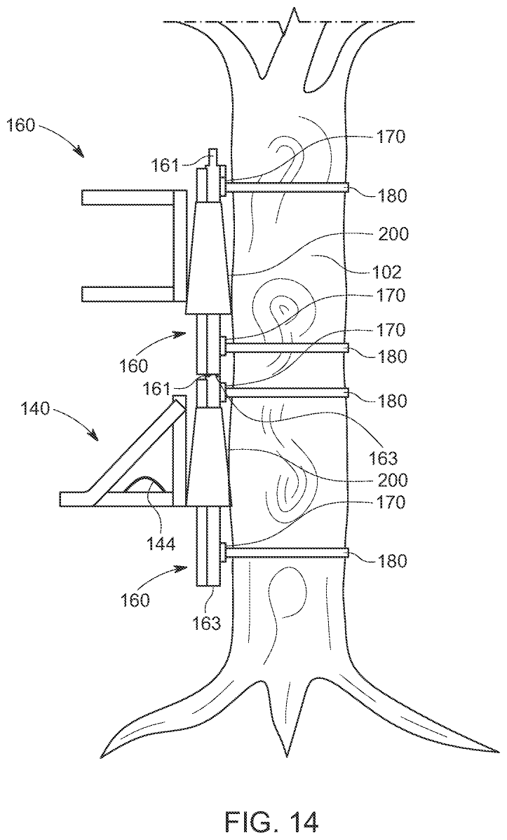

Referring to FIG. 13, a side elevational view showing the seat portion 120 of the tree stand 100 engaged with the rail 160 of the tree stand and the foot-rest portion 140 being lifted onto the rail 160 of the tree stand 100 is shown. As the foot-rest portion 140 is lifted, the rail climber mechanism 200 will cantilever outward (away from the tree 102) and the peg 206 will remain away from the holes in the rail 160. Once the foot-rest portion 140 is at a preferred level (see FIG. 14), the weight of the foot-rest portion 140 will cause the rail climber mechanism 200 will cantilever inwardly and allow the peg 206 to rest in the nearest engagement hole 166 as shown in FIG. 14.

Referring to FIG. 14, a side elevational view showing the seat portion 120 of the tree stand 100 and the foot-rest portion 140 of the tree stand 100 engaged with the rails 160 is shown. Note that the user is now shown for clarity and brevity reasons, but the configuration shown in FIG. 14 is ready for a user to climb into the seat portion 120 and rest their feet on the foot-rest portion 140. This tree stand 100 is not very high and most users will want to be located much higher than this in the tree 102. To accomplish this, the user will bring more sections of the rail 160 and install another rail section (not shown) above the rail sections that are already affixed to the tree 102 (e.g., rail sections 160A//160B).

Now it is suggested that the user secure chair and platform together with by tying a short section of rope between the seat portion 120 and the foot-rest portion 140 so that as the user performs the following steps, the foot-rest portion 140 does not drop out of reach of the user.

Now that the user has their feet on the foot-rest portion 140, the user places one or both feet into the foot straps 144 so that the user is able to pull up on the foot straps 144 and thereby, lift the foot-rest portion 140 one or more engagement holes 166 on the rail 160.

Now that the foot-rest portion 140 is higher, the user lifts up the seat portion 120 by push with their feet against the foot-rest portion 140, disengaging the peg 206 of the seat portion 120 and lifting the seat portion 120 where the peg 206 of the seat portion 120 is then engaged with a engagement hole 166 of the rail 160. As more rail 160 is required, the above process is used to add another section of rail 160 and the above steps are repeated to move the seat portion 120 and the foot-rest portion 140 higher and higher.

To descent, the process is reversed, lifting on the foot-rest portion 140 by having the user's feet in the straps, then keeping the foot-rest portion 140 at a slight angle to keep the peg 206 disengaged from the engagement holes 166 of the rail 160 and lowering the foot-rest portion 140 a few inches, then angling the foot-rest portion 140 to engage the peg 206 of the foot-rest portion 140 into an engagement hole 166 of the rail 160. Next, while standing on the foot-rest portion 140, the user lifts slightly on the seat portion 120 to disengage the peg 206 of the seat portion 120, then keeping the seat portion 120 at a slight angle to keep the peg 206 disengaged from the engagement holes 166 of the rail 160 and lowering the seat portion 120 a few inches, then angling the seat portion 120 to engage the peg 206 of the seat portion 120 into an engagement hole 166 of the rail 160. These steps are repeated until the seat portion 120 and the foot-rest portion 140 are close enough to the ground for the user to exit.

Although not shown, it is always recommended that the user employ a safety harness that is secured to the tree 102 (or other structure).

Once on the ground, the user is able to use the above process to remove the seat portion 120 and foot-rest portion 140 from the rail 160 and take the seat portion 120 and foot-rest portion 140 away from the hunting site or relocate the seat portion 120 and foot-rest portion 140 to another rail 160 that was previously affixed to a different tree or erected as per the above process on the different tree. In this way, if the user wants to be able to relocate their tree stand between multiple locations, it is anticipated that the user installs rails 160 at multiple locations on various trees, ready to climb using the user's seat portion 120 and foot-rest portion 140 and, if desired, friends of the user are able to utilize the rail 160 that the user erected.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction, and arrangement of the components thereof without departing from the scope and spirit of the invention or without sacrificing all of its material advantages. The form herein before described being merely exemplary and explanatory embodiment thereof. It is the intention of the following claims to encompass and include such changes.

The invention claimed is:

1. A tree stand comprising:
a rail having means for attaching and having a plurality of engagement holes on a face surface;
rail climber mechanisms having a front, a top edge, a bottom edge, and L-shaped sides, the L-shaped sides extend from the front and engage with the rail, slideably holds each of the rail climber mechanisms to the rail;
a peg is affixed or formed on an inside surface of the front between the bottom edge and a mid-point between the bottom edge and the top edge, and the L-shaped sides are wider at the bottom edge than at the top edge;
a seat portion affixed to a first rail climber mechanism of the rail climber mechanisms;
a foot-rest portion affixed to a second rail climber mechanism of the rail climber mechanisms; and
whereas the peg of the first rail climber mechanism engages with a first engagement hole of the rail until the seat portion is lifted and the peg of the second rail climber mechanism engages with a second engagement hole of the rail until the foot-rest portion is lifted.

2. The tree stand of claim 1, wherein the rail comprises two or more sections connected to each other.

3. The tree stand of claim 2, wherein the two or more sections of the rail are connected to each other by inserting a first end of one section of the two or more sections into a second end of another sections of the two or more sections.

4. The tree stand of claim 1, wherein the means for attaching comprises two or more straps interfaced to brackets, the brackets affixed to a back of the rail, the two or more straps for wrapping around a structure or a tree to secure the rail to the structure or the tree.

5. The tree stand of claim 4, wherein each of the two or more straps have a rachet-type tightening mechanism.

6. The tree stand of claim 1, wherein the foot-rest portion has foot straps on a top surface of the foot-rest portion, the foot straps for engaging with one or more feet of a user, enabling the user to lift up on the foot-rest portion to change a height of the foot-rest portion on the rail.

7. The tree stand of claim 1, wherein the rail comprises an engagement bar affixed to a structural bar, whereas the plurality of engagement holes is in the engagement bar.

8. A tree stand system comprising:
a rail having at least two brackets and a plurality of engagement holes formed on a face surface of the rail;
a first rail climber mechanism having a first front, a first top edge, a first bottom edge, and two first L-shaped sides, the two first L-shaped sides extend from the first front and engage with the rail, slideably holding the first rail climber mechanism to the rail, a first peg is affixed or formed on a first inside surface of the first front between the first bottom edge and a first mid-point between the first bottom edge and the first top edge, and each of the two first L-shaped sides is wider at the first bottom edge than at the first top edge;
a seat portion affixed to the first rail climber mechanism;
a second rail climber mechanism having a second front, a second top edge, a second bottom edge, and two second L-shaped sides, the two second L-shaped sides extend from the second front and engage with the rail, slideably holding the second rail climber mechanism to the rail, a second peg is affixed or formed on a second inside surface of the second front between the second bottom edge and a second mid-point between the second bottom edge and the second top edge, and each of the two second L-shaped sides are wider at the second bottom edge than at the second top edge;
a foot-rest portion affixed to the second rail climber mechanism, a top surface of the foot-rest portion having at least one foot strap; and
whereas the first peg of the first rail climber mechanism engages with a first engagement hole of the rail until the seat portion is lifted and the second peg of the second rail climber mechanism engages with a second engagement hole of the rail until the foot-rest portion is lifted.

9. The tree stand system of claim 8, wherein the rail comprises two or more sections of the rail connected to each other.

10. The tree stand system of claim 9, wherein the two or more sections of the rail are connected to each other by inserting a first end of one of the two or more sections of the rail into a second end of another one of the two or more sections of the rail.

11. The tree stand system of claim 8, wherein the rail is held to a structure by two or more straps that are interfaced to the at least two brackets, each of the at least two brackets is affixed to the rail.

12. The tree stand system of claim 11, wherein each of the two or more straps have a rachet-type tightening mechanism.

13. A method of installing a tree stand to a tree, the method comprising:
affixing a rail to the tree, the rail having a plurality of engagement holes;
slideably interfacing a climber mechanism of a seat portion to the rail from a bottom end of the rail by sliding the climber mechanism of the seat portion up the rail to a first desired height then engaging a peg of the climber mechanism of the seat portion into a first engagement hole of the rail;
slideably interfacing a climber mechanism of a foot-rest portion to the rail from the bottom end of the rail by sliding the climber mechanism of the foot-rest portion up the rail to a second desired height, the second desired height being lower than the first desired height, then engaging the peg of the climber mechanism of the foot-rest portion into a second engagement hole of the rail;
climbing onto the tree stand, resting your feet on the foot-rest portion and positioning your body on the seat portion, at least one foot of your feet being under a foot strap that is affixed to the foot-rest portion; and
until reaching a final height:
lifting the foot-rest portion using your legs, disengaging the peg of the climber mechanism of the foot-rest portion then further lifting the foot-rest portion, then lowering the foot-rest portion such that the peg of the climber mechanism of the foot-rest portion engages with a destination engagement hole of the rail that is higher than the second engagement hole; and
lifting the seat portion, disengaging the peg of the climber mechanism of the seat portion then further lifting the seat portion, then lowering the seat portion such that the peg of the climber mechanism of the seat portion engages with a second destination engagement hole of the rail that is higher than the first engagement hole.

14. The method of installing the tree stand of claim 13, wherein the affixing of the rail to the tree includes connecting straps to holes in a bracket, the bracket is affixed to the rail.

15. The method of installing the tree stand of claim 14, wherein the affixing of the rail to the tree includes tightening the straps using a rachet tightening mechanism.

16. The method of installing the tree stand of claim 13, wherein the rail comprises two or more sections of the rail connected to each other.

17. The method of installing the tree stand of claim 16, wherein the two or more sections of the rail are connected to each other by inserting a first end of one of the two or more sections of the rail into a second end of another one of the two or more sections of the rail.

18. The method of installing the tree stand of claim 16, wherein the rail comprises an engagement bar affixed to a structural bar, the engagement bar comprises the plurality of engagement holes.

19. The method of installing the tree stand of claim 18, wherein the engagement bar is affixed to the structural bar by welds.
